(19) United States
(12) Patent Application Publication
(10) Pub. No.: US 2005/0180617 A1
(43) Pub. Date: Aug. 18, 2005

(54) Image collating apparatus collating a set of snapshot images with another image, image collating method, image collating program product, and recording medium recording the program product

(75) Inventors: Manabu Yumoto, Nara-shi (JP); Yasufumi Itoh, Tenri-shi (JP); Manabu Onozaki, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/057,845

(22) Filed: Feb. 15, 2005

(30) Foreign Application Priority Data
Feb. 16, 2004 (JP) 2004-038392(P)

(51) Int. Cl. G06K 9/00; G06K 9/36

(52) U.S. Cl. 382/124; 382/284

(57) ABSTRACT

An image collating apparatus collating a set of snapshot images with another image different from the set of snapshot images is provided. The image collating apparatus includes a snapshot image relative positional relationship calculating part calculating relative positional relationship among the set of snapshot images Ak and similarity between the set of snapshot images Ak and an image B different from the set of snapshot images, and a collation determining part collating the set of snapshot images Ak with image B using the similarity to determine whether or not images Ak and image B match.

This nonprovisional application is based on Japanese Patent Application No. 2004-038392 filed with the Japan Patent Office on Feb. 16, 2004, the entire contents of which are hereby incorporated by reference.

### BACKGROUND OF THE INVENTION

1. Field of the Invention

The present invention relates to an image collating apparatus, an image collating method, an image collating program product, and a computer readable recording medium recording the image collating program product. More specifically, the present invention relates to an image collating apparatus, an image collating method, an image collating program product, and a computer readable recording medium recording the image collating program product collating a set of snapshot images with another image different from the set of snapshot images.

2. Description of the Background Art

Conventional collating methods of fingerprint images can broadly be categorized into the image feature matching scheme and the image matching scheme. The image feature matching scheme is, according to KOREDE WAKATTA BIOMETRICS(This is Biometrics) edited by Japan Automatic Identification Systems Association, OHM-sha, 2001, pp. 42-46, a method in which features contained in images are extracted, and thereafter not the images but the features are compared with each other. According to this method, when collating fingerprint images, minutiae (ridge ending and bifurcation of a ridge, contained by several to some tens of pieces in a fingerprint image) such as shown in FIGS. 7A and 7B correspond to the image features. According to this method, the number of matched minutiae between the images with respect to relative position and direction represents the similarity, based on information such as position and type of minutiae, ridges and the like extracted from respective images by image processing as shown in FIGS. 8A and 8B. Higher or lower similarity is presented depending on matching and mismatching in the number of ridges crossing between minutiae and the like. The similarity is compared with a predetermined threshold value to perform collation and identification.

On the other hand, according to the image matching scheme, as shown in FIGS. 9A and 9B, from images α1 and β1 to be collated, partial images α and β respectively corresponding to the entire or partial regions thereof are extracted. Matching between partial images α1 and β1 are calculated as the similarity between images α and β by the sum of differential values, correlation coefficient, phase correlation, group delay vector method or the like. The similarity is compared with a predetermined threshold value to perform collation and identification.

Examples of the inventions employing the image matching scheme are the inventions disclosed in Japanese Patent Laying-Open Nos. 63-211081 and 63-078286. Japanese Patent Laying-Open No. 63-211081 discloses a method, in which the image matching is performed, and thereafter partial regions are divided into four. The positions attaining maximum matching in peripheral regions of respective divided regions are determined, and similarity is corrected by average matching. Thus, distortion of a fingerprint image resulted in taking the fingerprint can be addressed. Japanese Patent Laying-Open No. 63-078286 discloses a method, in which constraint on positional relationship among a plurality of partial regions containing features of one fingerprint image is maintained to a certain extent to calculate the sum of matching with respective partial regions of the other fingerprint image as the similarity.

The problems of the image matching scheme and image feature matching scheme are disclosed in paragraphs 0006-0010 of Japanese Patent Laying-Open No. 2003-323618, which was filed and laid-open earlier by the applicant of the present invention.

Specifically, referring to the description, correct data cannot always be obtained with the conventional techniques when image data is input using a sensor. For example, when inputting image data of a fingerprint from a sensor, correct image data can hardly be obtained since there is positional displacement or tilt associated with placement of a finger on the sensor, difference in the pressure of the finger pressed against the sensor, deformation of a skin surface when pulling the finger and the like. When the skin surface is dry or wet, the image data may appear in a faded or smudged manner depending on the sensing method.

In case of the image feature matching scheme that utilizes minutiae of fingerprints, if fading is involved, a ridge that is actually continuous may be sensed as broken and thus a minutia that is not actually present may erroneously be extracted. If smudging is involved, information on minutiae cannot be extracted precisely, whereby stable image feature extraction can hardly be attained. Minutiae are not always distributed evenly over the surface of a person's finger. There are cases where few minutiae present, or the number of matching minutiae is extremely small due to positional displacement depending on the distribution of minutiae. Therefore, low similarity is presented when the number of matching minutiae is employed as the similarity.

Since features such as minutiae are not utilized, the image matching scheme is less susceptible to fading or smudging when determining the similarity with respect to the entire fingerprint image. However, tilt or deformation appearing on fingerprint images yields many mismatching parts between the fingerprint images even if they are of the identical fingerprint, and therefore low similarity between the fingerprint images is presented. When a plurality of partial images containing features of fingerprint images, a certain degree of tilt or deformation appearing on fingerprints can be addressed. On the other hand, matching in images of partial regions utilized as the similarity varies largely by a difference in the fingerprint images. Therefore, high similarity cannot always be obtained even with the fingerprint images of an identical person, and low similarity is presented due to tilt, the manner of pressing, the dryness of the finger.

As a result of the similarity of fingerprint images becoming lower than a predetermined threshold value, the fingerprint images may erroneously be determined that they are those of different fingers, while they are actually of an identical finger. If the threshold value is set lower in order to avoid such an erroneous determination, then it is more likely that the fingerprint images of different fingers are erroneously determined that they are those of an identical finger.

As described above, while collation between images have conventionally been performed by the similarity based on matching between image features or matching between image data, it has been difficult to attain high collation precision stably, since image data of the same target tends to present low similarity by variations in conditions in inputting image data.

Generally, the image matching scheme is more suitable to address noise, the condition of fingers (dryness, wetness, scars) and the like, whereas the image feature matching scheme can perform processing faster than the image matching scheme as the amount of data to be compared is smaller, and can perform matching by searching for relative positions and directions between feature points irrespective of tilt in the image.

In order to solve the problems of the image matching scheme and image feature matching scheme, the following is proposed in Japanese Patent Laying-Open No. 2003-323618. Specifically, maximum matching positions, which are those of a plurality of partial region images (FIGS. 10A and 10B) attaining maximum matching in the other image, are searched for, and the plurality of maximum matching positions are each compared with a predetermined threshold value (FIG. 10C) to calculate the similarity between the two images.

As shown in FIGS. 11 and 12, conventional input methods as to a fingerprint image can basically be categorized into the area sensing scheme (FIG. 11) and the sweep sensing scheme (FIG. 12). The area sensing scheme is for inputting fingerprint information sensed by the entire area at once, whereas the sweep sensing scheme is for sensing the fingerprint while moving the finger on a sensor. The invention disclosed in Japanese Patent Laying-Open No. 2003-323618 relates to the area sensing scheme. The area sensing scheme requires a sensor of larger area as compared with the sweep sensing scheme, in order to improve the fingerprint authentication precision. Furthermore, for example a semiconductor sensor is less cost-effective relative to the area, since silicon costs high as the material. Therefore, the sweep sensing scheme is more advantageous for a mobile device or the like that is necessary to be small in the installation area and to be cost-effective.

However, while the sweep sensing scheme has the advantage of being small in the installation area and being cost-effective, it cannot always obtain correct data when inputting image data using a sensor. Particularly, in the sweep sensing method, since snapshot images are generally connected to be one image and thereafter collation with another image is performed, there are such problems that much time is taken for image composition, and that connection portions are not made continuous with each other in the image connecting process due to varied moving speed of a finger, whereby the authentication precision is deteriorated.

In order to solve such problems, Japanese Patent Laying-Open No. 05-174133 discloses an optical apparatus, which is a fingerprint sensor with a rotary encoder obtaining an image while detecting the moving speed of a finger. Since the optical apparatus disclosed in Japanese Patent Laying-Open No. 05-174133 obtains the image of the finger while detecting the moving speed of the finger toward the moving direction, it can obtain an image sampled by a constant distance despite of varied moving speed in the direction which can be sensed by the rotary encoder. However, it involves the problems that the apparatus is large in size and high in costs as the rotary encoder is required, and that detection of the moving speed is difficult when the finger moves in a direction different from that which the rotary encoder can detect.

The present invention has been made to solve the problems described above, and an object thereof is to provide an image collating apparatus, an image collating method, an image collating program product, and a computer readable recording medium recording an image collating program product that can achieve high collation precision without incurring additional costs with the sensor and irrespective of varied finger moving speed (and direction).

### SUMMARY OF THE INVENTION

In order to achieve the aforementioned object, in accordance with an aspect of the present invention, an image collating apparatus includes: an image relative positional relationship calculating part calculating a first reference position that is relative positional relationship between two images picked up and obtained by scanning an identical target, based on matching of at least part of regions between the two images; a first maximum matching position searching part searching for a first maximum matching position for each of the two images, the first maximum matching position being a position of an image of a partial region attaining maximum matching in another image different from the two images; a first similarity calculating part calculating image similarity between the two images and the another image to output the calculated image similarity, by using information on the partial region corresponding to first positional relationship data included in a predetermined range out of first positional relationship data for each of the two images representing positional relationship between the first reference position calculated by the image relative positional relationship calculating part and the first maximum matching position calculated by the first maximum matching position searching part; and a determining part determining whether or not the two images and the another image match based on the image similarity.

Preferably, the image relative positional relationship calculating part includes a second maximum matching position searching part searching for a second maximum matching position for each of the two images, the second maximum matching position being each of positions of images of partial regions at which a part of a plurality of images in one of the two images respectively attain maximum matching in other of the two images, a second similarity calculating part calculating image similarity between the two images to output the calculated image similarity, by using information on the part of images corresponding to second positional relationship data included in a predetermined range out of second positional relationship data for each of the plurality of partial images of the one of two images representing positional relationship between a reference position for measuring a position of the part of images in the other image and the second maximum matching position corresponding to the part of images searched for by the second maximum matching position searching part, and a reference position calculating part calculating the first reference position of the one of the images in the other image based on the second positional relationship data.

Preferably, the reference position calculating part calculates the first reference position based on an average value of a plurality of the second positional relationship data.

Preferably, the reference position calculating part extracts arbitrary second positional relationship data out of a plurality of the second positional relationship data, and calculate the first reference position based on the extracted second positional relationship data.

In accordance with another aspect of the present invention, an image collating method includes the steps of: calculating a first reference position that is relative positional relationship between two images picked up and obtained by scanning an identical target, based on matching of at least part of regions between the two images; searching for a first maximum matching position for each of the two images, the first maximum matching position being a position of an image of a partial region attaining maximum matching in another image different from the two images; calculating image similarity between the two images and the another image to output the calculated image similarity, by using information on the partial region corresponding to first positional relationship data included in a predetermined range out of first positional relationship data for each of the two images representing positional relationship between the calculated first reference position and the searched first maximum matching position; and determining whether or not the two images and the another image match based on the image similarity.

In accordance with a further aspect of the present invention, an image collating program product causes a computer to execute an image collating method. The program product causes the computer to execute the steps of: calculating a first reference position that is relative positional relationship between two images picked up and obtained by scanning an identical target, based on matching of at least part of regions between the two images; searching for a first maximum matching position for each of the two images, the first maximum matching position being a position of an image of a partial region attaining maximum matching in another image different from the two images; calculating image similarity between the two images and the another image to output the calculated image similarity, by using information on the partial region corresponding to first positional relationship data included in a predetermined range out of first positional relationship data for each of the two images representing positional relationship between the calculated first reference position and the searched first maximum matching position; and determining whether or not the two images and the another image match based on the image similarity.

In accordance with a still further aspect of the present invention, a computer readable recording medium stores the aforementioned image collating program product.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram representing a feature configuration of an image collating apparatus 1 according to a first embodiment.

FIG. 2 is an illustration showing a specific example of a configuration of a computer in which an image collating apparatus according to each embodiment is incorporated.

FIG. 3 is a flowchart representing an image collation process according to the first embodiment.

FIG. 4 is a flowchart representing a process of calculating relative positional relationship between snapshot images Ak at step T23.

FIG. 5A is an illustration related to a description of a specific example of snapshot images.

FIG. 5B is an illustration related to a description of a specific example of snapshot images of which relative positional relationship is corrected.

FIG. 5C is an illustration related to a description of a status of searching for positions showing the maximum matching.

FIG. 5D is an illustration related to a description of moving vectors of the corrected snapshot images and distribution thereof.

FIG. 6 is a flowchart showing a collation process at step T3.

FIGS. 7A and 7B represent the image matching method of a conventional technique.

FIGS. 8A and 8B represent the image feature matching method of a conventional technique.

FIGS. 9A and 9B are schematic diagrams of minutiae that are image features used in a conventional technique.

FIGS. 10A-10C are illustrations showing search result of the positions of high matching with respect to a plurality of partial regions in a pair of fingerprint images obtained from different fingerprints, moving vectors of respective partial regions and distribution.

FIG. 11 is an illustration related to a description of an area sensing scheme that is a conventional input method of a fingerprint image.

FIG. 12 is an illustration related to a description of a sweep sensing scheme that is a conventional input method of a fingerprint image.

### DESCRIPTION OF THE PREFERRED EMBODIMENTS

An embodiment of the present invention will be described hereinafter with reference to the drawings. The same elements have the same reference characters allotted. Their name and function are also identical. Therefore, detailed description thereof will not be repeated.

Here, a set of snapshot images are collated with another image data different from the set of snapshot images. While fingerprint image data is exemplary shown as image data of collation target, the image data is not restricted thereto, and it may be image data based on other feature of a living body that is similar but never be identical among individuals.

First Embodiment

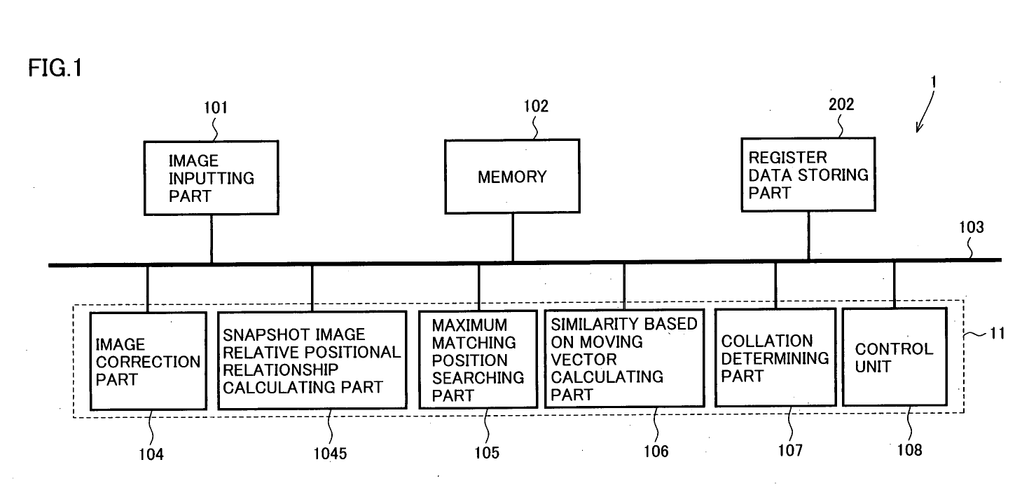

FIG. 1 is a block diagram representing a feature configuration of an image collating apparatus 1 according to a first embodiment.

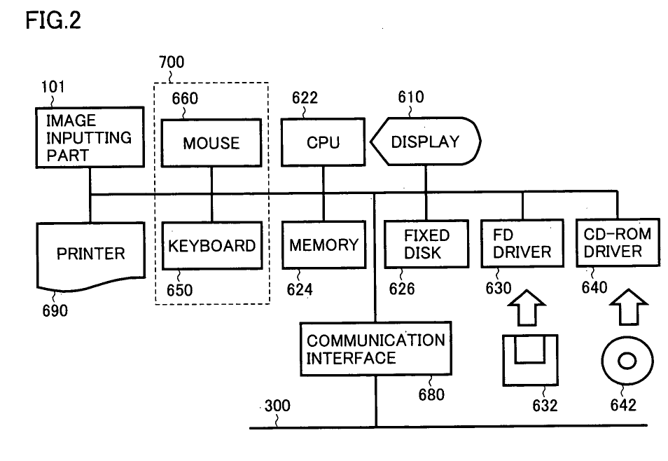

Referring to FIG. 1, the image collating apparatus according to the first embodiment includes an image inputting part 101, a memory 102 corresponding to a memory 624 or a fixed disk 626 (FIG. 2), a bus 103, a register data storing part 202, and a collation processing part 11.

Collation processing part 11 includes an image correcting part 104, a snapshot image relative positional relationship calculating part 1045, a maximum matching position searching part 105, a similarity based on moving vector calculating part (hereinafter referred to as similarity calculating part) 106, a collation determining part 107, and a control unit 108. Each function of collation processing part 11 is realized by execution of a corresponding program.

Image inputting part 101 includes a fingerprint sensor, and outputs fingerprint image data corresponding to the fingerprint read by the fingerprint sensor. Any of optical, pressure or capacitor scheme can be applied to the fingerprint sensor.

In memory 102, image data, various calculation result and the like are stored. Bus 103 is used for sending out control signals and data signals among the components. Image correcting part 104 performs density correction to the fingerprint image data input from image inputting part 101.

Maximum matching position searching part 105 performs so-called template matching, in which a plurality of partial regions of one fingerprint image are used as templates to search for positions at which the templates attain maximum matching in the other fingerprint image. Result information that is a search result is passed to memory 102 and stored therein.

Similarity calculating part 106 uses the result information of maximum matching position searching part 105 stored in memory 102 to calculate similarity based on the moving vector that will be described later. The calculated similarity is passed to similarity determining part 107. Similarity determining part 107 determines matching and mismatching by the similarity calculated by similarity calculating part 106.

Control unit 108 controls processing at each component of collating processing part 11. In register data storing part 202, only the data for collation is stored in advance from an image different from the set of snapshot images to be collated.

It is noted that, in the present embodiment, part of or all of image correcting part 104, snapshot image relative positional relationship calculating part 1045, maximum matching position searching part 105, similarity calculating part 106, collation determining part 107, and control unit 108 may be configured using a processor including ROM such as memory 624 (FIG. 2) with processing procedures stored therein as a program, CPU 622 (FIG. 2) for executing the program and the like.

FIG. 2 is an illustration showing a specific example of a configuration of a computer functioning as an image collating apparatus according to each embodiment.

Referring to FIG. 2, the computer includes an image inputting part 101, a display 610 configured by CRT (Cathode-Ray Tube), liquid crystal or the like, CPU (Central Processing Unit) 622 for managing and controlling the computer in a centralized manner, a memory 624 configured to contain ROM (Read Only Memory) or RAM (Random Access Memory), a fixed disk 626, an FD (Flexible Disk) driver 630 to which an FD 632 is removably attached to be accessed, a CD-ROM (Compact Disc Read Only Memory) driver 640 to which a CD-ROM 642 is removably attached to be accessed, a communication interface 680 connecting a communication network and the computer for communication, and an inputting part 700 having a keyboard 650 and a mouse 660. These components are connected for communication via the bus. The computer is connected to a printer 690 that is an external apparatus.

It is noted that the configuration shown in FIG. 2 is a general configuration of a computer, and a configuration of the computer according to the present embodiment is not restricted thereto. For example, the computer may be provided with a magnetic tape apparatus to which a magnetic tape of a cassette format is movably attached to be accessed.

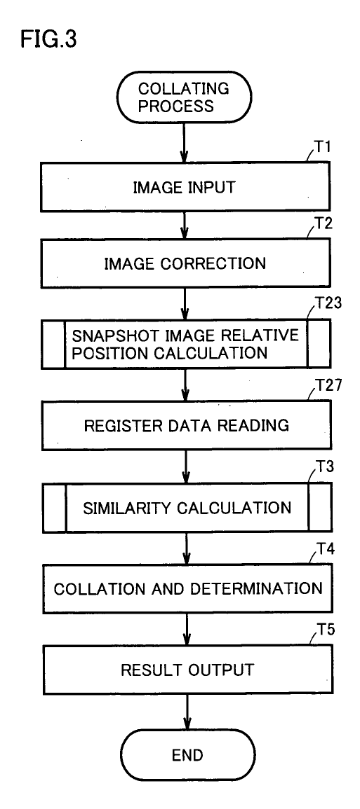

Referring to a flowchart of FIG. 3, a process for collating a set of snapshot images Ak with an image B different from the set of snapshot images Ak in image collating apparatus 1 of FIG. 1 will be described. The process shown in the flowchart of FIG. 3 is realized by CPU 622 of the computer functioning as the image collating apparatus according to the present embodiment reading a corresponding program stored in ROM or the like, and developing it on RAM for execution so that the components shown in FIG. 1 are controlled.

Referring to FIG. 3, first, control unit 108 sends out a signal of image input initiation to image inputting part 101, and thereafter waits for reception of an image input end signal. Image inputting part 101 receives an input of data of images Ak to be collated, and stores it at a predetermined address in memory 102 through bus 103 (step T1). When the input of data of images Ak is completed, image inputting part 101 sends out the image input end signal to control unit 108.

Next, control unit 108 sends out an image correction initiation signal to image correcting part 104, and thereafter waits for reception of an image correction end signal. Often, since density value of each pixel or overall density distribution of input image varies in accordance with the characteristics of image inputting part 101, the degree of dryness or pressure of the pressing finger and the like, image quality is not uniform. Therefore, it is not appropriate to use input image data for collation as it is. Accordingly, image correcting part 104 corrects image data of an input image so as to suppress the effect of variations in conditions of inputting the image (step T2). Specifically, for the entire image corresponding to the input image data or for each of small regions corresponding to the divided image, histogram averaging, as described in Computer GAZOU SHORI NYUMON (Introduction to computer image processing) Souken Shuppan, 1985, p.98-99, binarization process of the image data as described in Computer GAZOU SHORI NYUMON (Introduction to computer image processing) Souken Shuppan, 1994, pp. 66-69, or the like is performed to the data of images Ak stored in memory 102.

When the image correction process to the data of images Ak at step T2 is completed, image correcting part 104 sends out the image correction process end signal to control unit 108.

Next, a process of calculating the relative positional relationship between snapshot images Ak (step T23) is performed. The process at T23 will be described in detail later with a subroutine.

When the process of calculating the relative positional relationship between snapshot images Ak at step T23 is completed, control unit 108 sends out a register data read initiation signal to register data reading part 207, and waits for reception of a register data read end signal.

Receiving the register data read initiation signal, register data reading part 207 reads data of partial regions Ri of a register image B from register data storing part 202 and stores it at a predetermined address in memory 102 (step T27).

Next, a process of calculating similarity between a set of snapshot images Ak and image B different from the set of snapshot images Ak is performed (step T3). The process at T3 will be described in detail later with a subroutine.

When the collating process at step T3 is completed, control unit 108 sends out a collation determination initiation signal to collation determining part 107, and waits for reception of a collation determination end signal. Collation determining part 107 uses the calculation result at step T3 for collation and makes determination (step T4). The specific determination method at step T4 will be described in detail in the description of the similarity calculation process at step T3.

Next, when determination at step T4 is completed, collation determining part 107 stores a collation result that is the collation determination result in memory 102, and sends out the collation determination end signal to control unit 108, whereby the process is completed.

Finally, control unit 108 outputs the collation result stored in memory 102 through display 610 or printer 690 (step T5), whereby the image collation is completed.

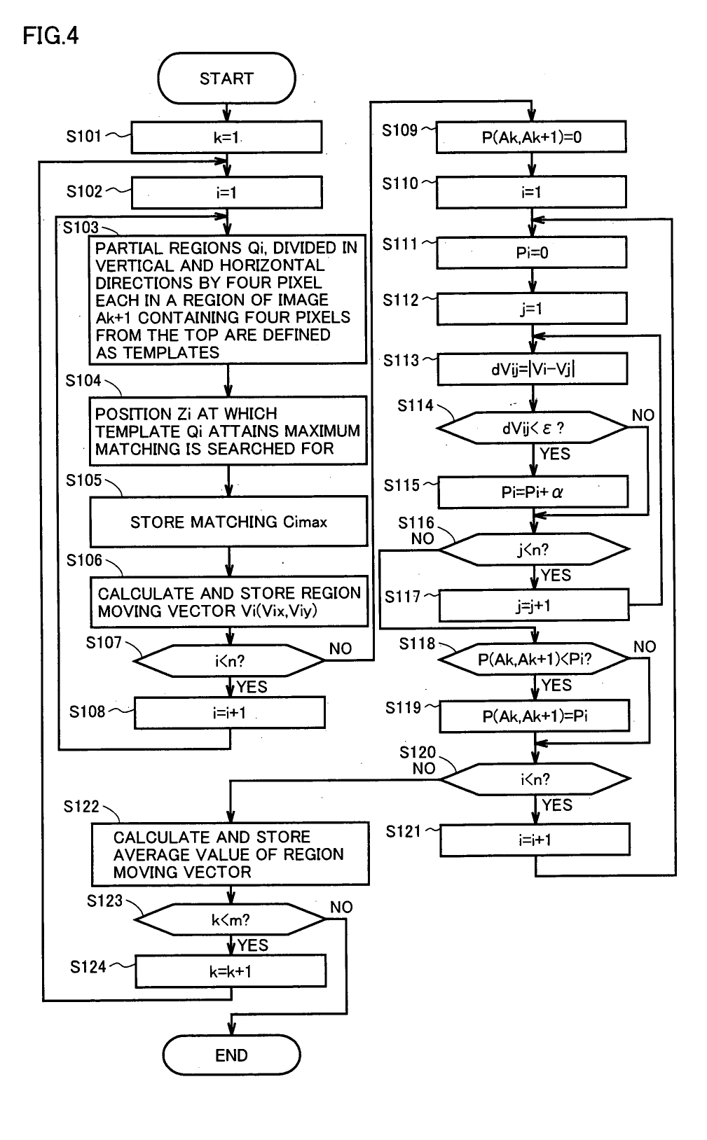

Next, the aforementioned process at step T23 will be described, referring to FIG. 4.

First, control unit 108 sends out a template matching initiation signal to snapshot image relative positional relationship calculating part 1045, and wait for reception of a template matching end signal. At snapshot image relative positional relationship calculating part 1045, a template matching process as shown in steps S101-S108 is performed.

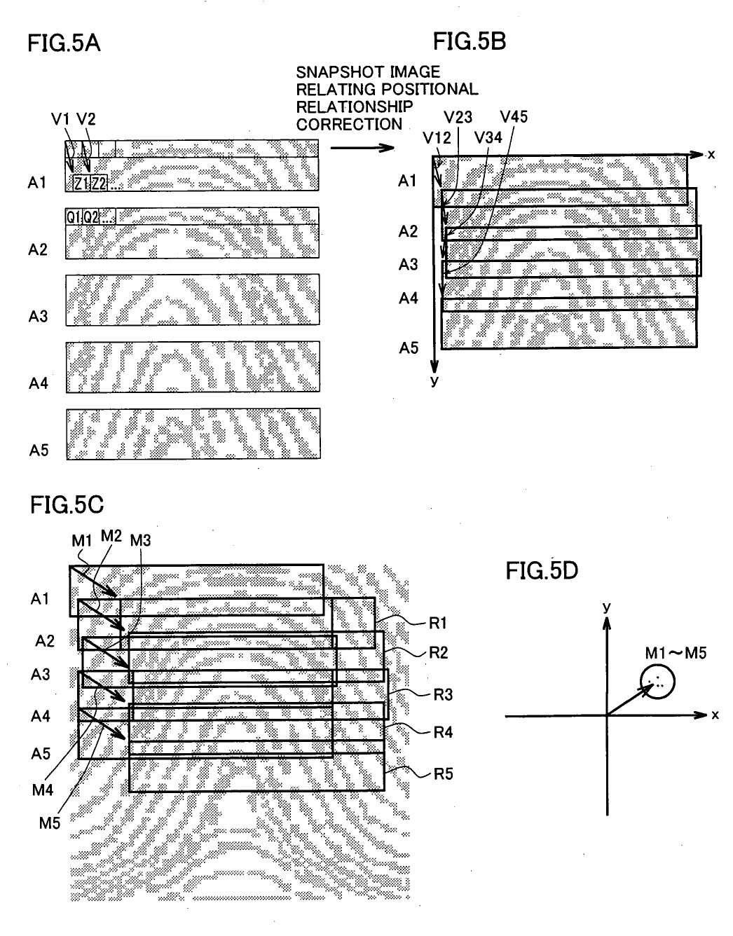

Here, the template matching process is the one performed with respect to snapshot images Ak and Ak+1, for searching for positions at which a plurality of partial images of image Ak+1 respectively attain maximum matching with partial regions of image Ak, i.e., the process of searching for maximum matching positions. For example, referring to the images shown in FIG. 5A as a specific example, the positions at which partial images Q1, Q2 . . . of snapshot image A2 respectively attain maximum matching in partial images Z1, Z2 . . . of snapshot image A1 are searched for. This will be described in detail in the following.

First, at steps S101 and S102, counter variables k and i are initialized to 1. Next, at step S103, partial regions Qi, divided in vertical and horizontal directions by four pixel each, in a region of image Ak+1 containing four pixels from the top, are defined to be used as templates in template matching. Here, each partial region Qi is shown to be rectangular for ease of calculation, the shape of partial region Qi is not restricted thereto.

Next, at step S104, positions at which the templates set at step S103 attain maximum matching in image Ak, i.e., are closest to data in the image, are searched for. Specifically, it is performed in the following manner. Here, the pixel density at coordinates (x, y) with respect to the upper left corner of partial regions Qi used as the templates is expressed as Qi (x, y). The pixel density at coordinates (s, t) with respect to the upper left corner of image Ak is expressed as Ak (s, t). The width of partial region Qi is expressed as w, whereas the height thereof is expressed as h. The maximum density that can be attained by each pixel of partial regions Qi and image Ak is expressed as VO. Matching Ci (s, t) at coordinates (s, t) in image Ak is calculated, based on the difference in density among respective pixels, for example according to the following equation (1).

$$Ci ( s , t ) = {\sum }_{y = 1}^{h} {\sum }_{x = 1}^{w} ( V 0 - \vert Qi ( x , y ) - Ak ( s + x , t + y ) \vert ) \qquad ( 1 )$$

Coordinates (s, t) in image Ak are successively updated, and matching C (s, t) at coordinates (s, t) is calculated. It is defined that a position taking the maximum value attains maximum matching. It is also defined that an image of the partial region at that position is a region Zi. It is also defined that matching at that position is a maximum matching Cimax.

At step S105, maximum matching Cimax of partial region Qi in image Ak calculated at step S104 is stored at a predetermined address in memory 102. Further, at step S106, a moving vector Vi is calculated according to the following equation (2), and stored at a predetermined address in memory 102.
Vi=(Vix, Viy)=(Zix−Qix, Ziy−Qiy) (2)

Here, as described above, based on partial region Qi corresponding to position Q set in image Ak+1, when image Ak is scanned to specify therein partial region Zi of position Z with which partial region Qi matches the most, the direction vector from position Q to position Z is referred to as a moving vector.

In equation (2), variables Qix and Qiy are x and y coordinates of the reference position of partial region Qi, and for example, correspond to the coordinates at the upper left corner of partial region Qi in image Ak. Variables Zix and Ziy are x and y coordinates at the position of maximum matching Cimax that is the search result of partial region Zi, and for example, correspond to the coordinates at the upper left corner of partial region Zi at the matched position in image Ak.

Next, at step S107, whether or not counter variable i is at most the number of partial regions n is determined. If the value of variable i is at most the number of partial regions n, then the process is advanced to S108. Otherwise, the process is advanced to S109.

At step S108, variable i is incremented by 1. Subsequently, as long as the value of variable i is at most the number of partial regions n, the process of steps S103-S108 is repeated, and each partial region Qi is subjected to template matching. Maximum matching Cimax and moving vector Vi of each partial region Qi are calculated.

Maximum matching position searching part 105 stores maximum matching Cimax and moving vector Vi for every partial region Qi successively calculated as above at a predetermined address in memory 102. Thereafter, maximum position searching part 105 sends out a template matching end signal to control unit 108 to complete the process.

Subsequently, control unit 108 sends out a similarity calculation initiation signal to similarity calculating part 106, and waits for reception of a similarity calculation end signal. Similarity calculating part 106 uses information such as moving vector Vi and maximum matching Cimax of each partial region Qi obtained by template matching and stored in memory 102, and execute the process of steps S109-S120 to perform similarity calculation.

Here, the similarity calculation process is the one of calculating the similarity between two images Ak and Ak+1, using the maximum matching position corresponding to each of a plurality of partial images obtained by the template matching process described above. This will be described in detail in the following. It is noted that normally the data of snapshot images is obtained from an identical person, and therefore this similarity calculating process may not be performed.

At step S109, similarity P (Ak, Ak+1) is initialized to 0. Here, similarity P (Ak, Ak+1) is a variable where similarity of images Ak and Ak+1 is stored. Next, at step S110, index i of moving vector Vi to be the reference is initialized to 1. At step S111, similarity Pi related to moving vector Vi to be the reference is initialized to 0. At step S112, index j of moving vector Vj is initialized to 1.

At step S113, vector difference dVij between reference moving vector Vi and moving vector Vj is calculated according to the following equation (3).
dVij=|Vi−Vj|=sqrt{(Vix−Vjx)²+(Viy−Vjy)²} (3)

Here, variables Vix and Viy are x and y direction components of moving vector Vi. Variables Vjx and Vjy are x and y direction components of moving vector Vj. Variable sqrt(X) expresses the square root of X. X² is an expression for calculating the square of X.

At step S114, vector difference dVij between moving vectors Vi and Vj is compared with a predetermined constant ε, and whether or not moving vectors Vi and Vj can be regarded as a substantially identical moving vector is determined. Specifically, if vector difference dVij is smaller than constant ε(YES at S114), then moving vectors Vi and Vj are regarded to be substantially identical, and the process is advanced to step S115. Conversely, if it is greater (NO at S114), then they are not regarded to be substantially identical, and step S115 is skipped and the process is advanced to step S116. At step S115, similarity Pi is increased by using the following equations (4)-(6).
Pi=Pi+α (4)
α=1 (5)
α=Cjmax (6)

Variable α in equation (4) is a value that increases similarity Pi. Accordingly, when variable α is set as α=1 as shown in equation (5), similarity Pi is the number of partial regions having the identical moving vector with reference moving vector Vi. When variable α is set as α=Cjmax as shown in equation (6), similarity Pi is the sum of maximum matching when performing template matching with respect to the partial regions having the identical moving vector with reference moving vector Vi. The value of α may be smaller in accordance with the magnitude of vector difference dVij.

At step S116, whether or not index j is smaller than the number of partial regions n is determined, and if it is determined that index j is smaller than the number of partial regions n (YES at S116), then the process is advanced to step S117, and if it is determined that it is greater (NO at S116), then the process is advanced to step S118. Specifically, at step S117, the value of index j is incremented by 1.

By the process of steps S111-S117 described above, similarity Pi using information of partial regions determined to have the same moving vector with respect to moving vector Vi of the reference is calculated. Then, at step S118, similarity Pi obtained using moving vector Vi as the reference is compared with variable P (Ak, Ak+1). If similarity Pi is greater than that which is maximum up to the current point (value of variable P (Ak, Ak+1)) (YES at S118), then the process is advanced to S119, and if smaller (NO at S118), then step S 119 is skipped and the process is advanced to S120.

Specifically, at step S119, as variable P (Ak, Ak+1), the value of similarity Pi derived by using moving vector Vi as the reference is set. At steps S118 and S119, if similarity Pi derived by using moving vector Vi as the reference is greater than the maximum value of the similarity (value of variable P (Ak, Ak+1)) derived by using other moving vectors as the reference calculated up to this time point, then moving vector Vi being the reference is most appropriate as the reference among indexes i up to the current time point.

Next, at step S120, the value of index i of moving vector Vi of the reference and the number of partial regions n (value of variable n) are compared. If index i is smaller than the number of partial regions n (YES at S120), then the process is advanced to step S121, and index i is incremented by 1.

By repeating the process of steps S109-S120 until index i reaches the number of partial regions n (NO at S120), the similarity between images Ak and Ak+1 is calculated as the value of variable P (Ak, Ak+1). Similarity calculating part 106 stores the value of variable P (Ak, Ak+1) calculated as above at a predetermined address in memory 102, and at step S122, calculates average value of region moving vector Vk, k+1 according to the following equation (7).

$$Vk , k + 1 = ( {\sum }_{i = 1}^{n} Vi ) / n \qquad ( 7 )$$

An average value of region moving vector Vk, k+1 obtained by equation (7) above is specifically shown in FIG. 5B.

Here, the average value of region moving vector Vk, k+1 is calculated for deriving the relative positional relationship between snapshot images Ak and Ak+1 based on the average value of a set of moving vectors Vi of partial regions Qi of the snapshot images. For example, in the specific example shown in FIG. 5B, the average vector of region moving vectors V1, V2 . . . is V12.

Next, at step S123, the value of index k of snapshot image Ak, which is the reference image, and the number of snapshot images (value of variable m) are compared. If index k is smaller than the number of snapshot images m (YES at S123), then the process is returned to step S102 after index k is incremented by 1 at step S124, and the process described above is repeated. Then, when index k is smaller than the number of snapshot images m (NO at S123), a calculation end signal is sent out from control unit 108 to snapshot image relative positional relationship calculating part 1045, and the process is completed.

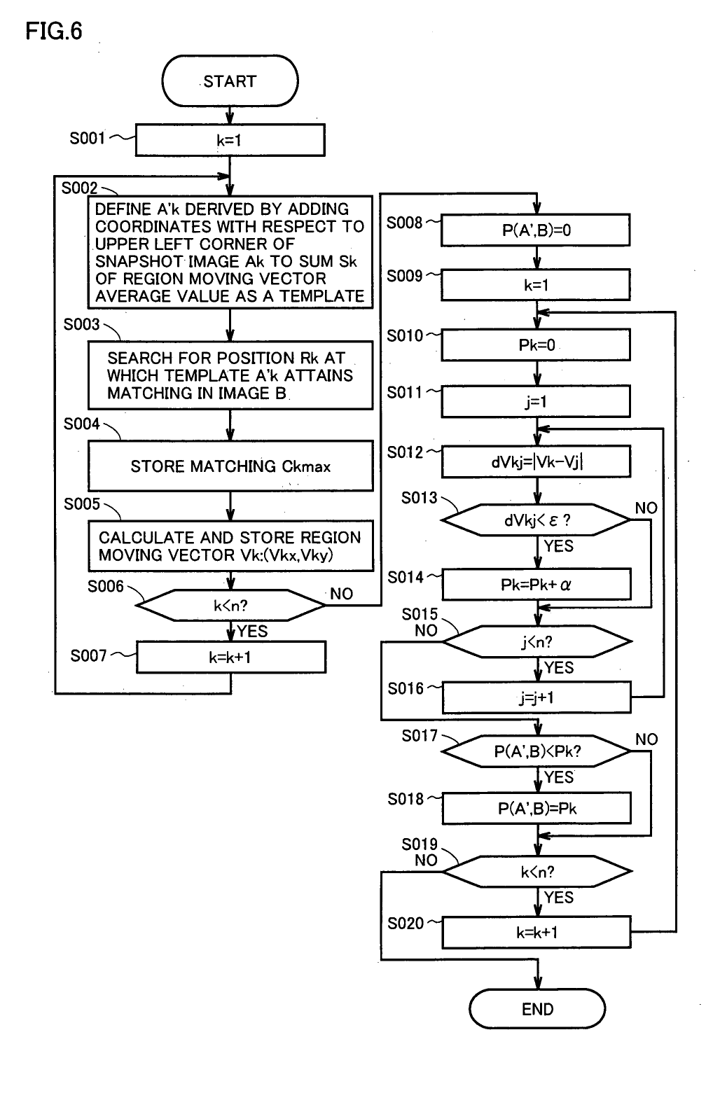

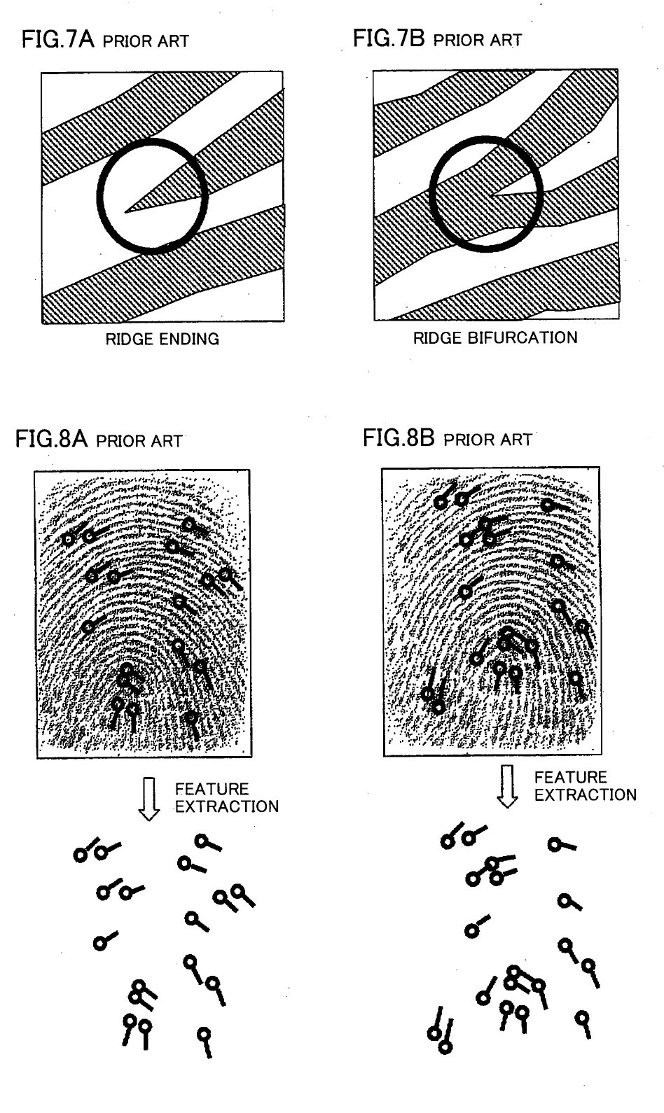

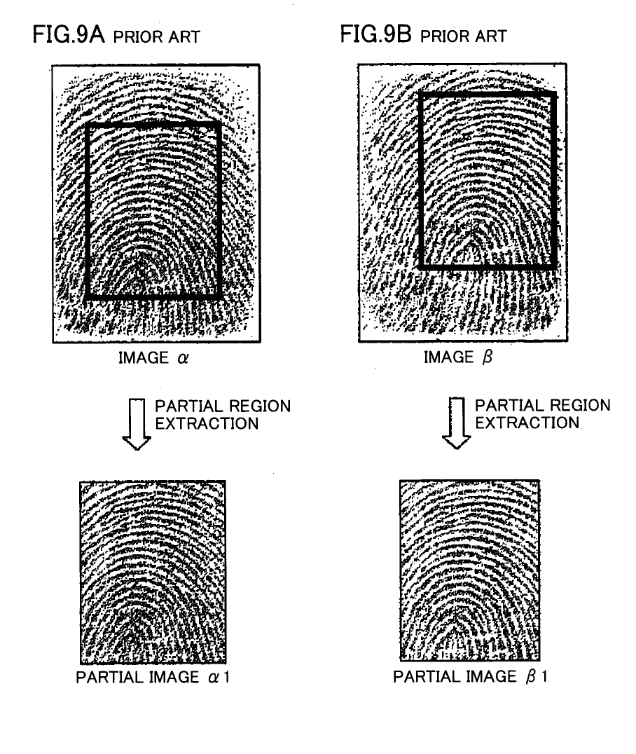

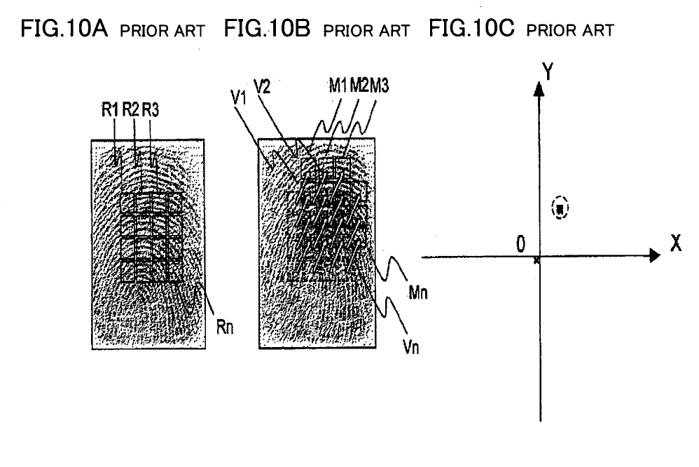

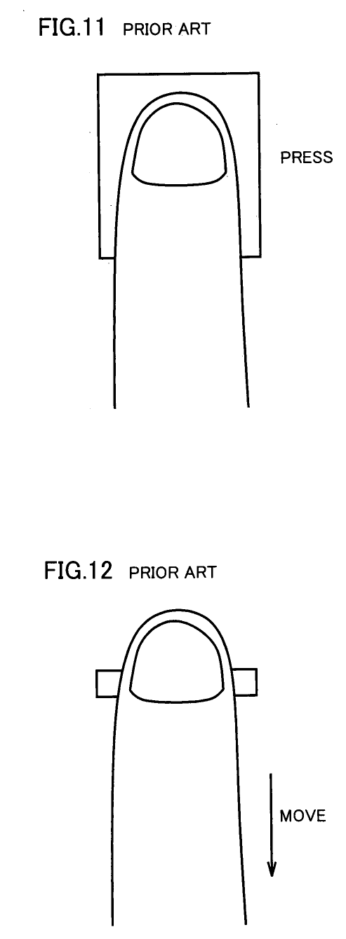

Next, the aforementioned collation process performed at step T3 will be described, referring to the flowchart of FIG. 6.

Control unit 108 sends out a template matching initiation signal to maximum matching position searching part 105, and waits for reception of a template matching end signal. Maximum matching position searching part 105 initiates the template matching process as shown in steps S001-S007.

Here, the template matching process is the one of searching for maximum matching positions, which are positions of images of partial regions at which a set of snapshot images reflecting the reference positions calculated at snapshot image relative positional relationship calculating part 1045 respectively attain maximum matching in another image different from the set of snapshot images. In the following, this process is described in detail.

First, at step S001, counter variable k is initialized to 1. Next, at step S002, an image of a partial region defined as A′k, which is derived by adding the coordinates with respect to the upper left corner of snapshot image Ak to the sum SkPk of region moving vector average value Vk, k+1, is set as a template to be used in template matching. Here, SkPk is defined by the following equation.

$$SkPk = {\sum }_{i = 1}^{i - 1} Vi - 1 , i$$

At step S003, positions at which the template being set at step S002 attain maximum matching in image B, i.e., with data in the image, are searched for. Specifically, the process is performed as follows. Here, the pixel density at coordinates (x, y) with respect to the upper left corner of partial region A′k used as the template is expressed as A′k (x, y). The pixel density at coordinates (s, t) with respect to the upper left corner of image B is expressed as B (s, t). Width of partial region A′k is expressed as w, whereas height thereof is expressed as h. The maximum density that can be attained by each pixel of images A′k and B is expressed as V0. Matching Ci (s, t) at coordinates (s, t) in image B is calculated, based on the difference in density among respective pixels, for example according to the following equation (8).

$$Ci ( s , t ) {\sum }_{y = 1}^{h} {\sum }_{x = 1}^{w} ( V 0 - \vert {A}^{′} k ( x , y ) - B ( s + x , t + y ) \vert ) \qquad ( 8 )$$

Coordinates (s, t) in image B are successively updated, and matching C (s, t) at coordinates (s, t) is calculated. It is defined that a position taking the maximum value attains maximum matching. It is also defined that an image of the partial region at that position is a region Rk. It is also defined that matching at that position is a maximum matching Ckmax. At step S004, maximum matching Ckmax of partial region A′k in image B calculated at step S003 is stored at a predetermined address in memory 102. At step S005, moving vector Vk is calculated according to the following equation (9), and stored at a predetermined address in memory 102.
Vk=(Vkx, Vky)=(Rkx−A′kx, Rky−A′ky) (9)

Here, as described above, based on A′k, when image B is scanned to specify therein partial region Rk of position R with which partial region A′k matches the most, the direction vector from position A′ to position R is referred to as a moving vector. The moving vector is specifically shown in FIG. 5C. As placement of a finger on a fingerprint sensor is not uniform, with reference to one of the images, for example image A, the other image B appears to move.

In equation (9), variables A′kx and A′ky are x and y coordinates at the reference position of partial region A′k, which is derived by adding the coordinates with respect to the upper left corner of snapshot image Ak to the sum Pn of region moving vector average value Vk, k+1. Variables Rkx and Rky are x and y coordinates at the position of maximum matching Ckmax that is a search result of partial region Rk, and for example, correspond to the coordinates at the upper left corner of partial region Rk at the matched position in image B.

At step S006, whether or not counter variable k is at most the number of partial regions n is determined. If the value of variable k is at most the number of the number of partial regions n (YES at S006), then the process is advanced to S007. Otherwise (NO at S006), the process is advanced to S008. Specifically, at step S007, the value of variable k is incremented by 1. Subsequently, as long as the value of variable k is at most the number of partial regions n, the process of steps S002-S007 is repeated, and each partial region A′k is subjected to template matching. Maximum matching Ckmax and moving vector Vk of each partial region A′k are calculated.

Maximum matching position searching part 105 stores maximum matching Ckmax and moving vector Vk for every partial region A′k successively calculated as above at a predetermined address in memory 102, and thereafter, it sends out a template matching end signal to control unit 108 to complete the process.

Subsequently, control unit 108 sends out a similarity calculation initiation signal to similarity calculating part 106, and waits for reception of a similarity calculation end signal. Similarity calculating part 106 uses information such as moving vector Vk and maximum matching Ckmax of each partial region A′k obtained by template matching and stored in memory 102, and perform the process of steps S008-S020 to perform similarity calculation.

Here, in the similarity calculation process, maximum matching positions, which are positions of images of partial regions at which a set of snapshot images reflecting the reference positions calculated at snapshot image relative positional relationship calculating part 1045 respectively attain maximum matching in another image different from the set of snapshot images, are searched by the template matching process described above. Subsequently, by determining that each positional relationship data representing positional relationship between the reference position and the searched maximum matching positions corresponding to respective partial regions is within a predetermined threshold value range, similarity is determined. Based on the similarity, whether or not the set of snapshot images match this another image is determined. In the following, this process is described in detail.

At step S008, similarity P (A′B) is initialized to 0. Here, similarity P (A′B) is a variable where similarity of images A′ and B is stored. At step S009, index i of moving vector Vk to be the reference is initialized to 1. At step S010, similarity Pk with respect to moving vector Vk to be the reference is initialized to 0. At step S011, index j of moving vector Vj is initialized to 1.

At step S012, vector difference dVkj between reference moving vector Vk and moving vector Vj is calculated according to the following equation (10).
dVkj=|Vk−Vj|=sqrt{(Vkx−Vjx)²+(Vky−Viy)²} (10)

Here, variable Vkx and Vky are x and y direction components of moving vector Vk. Variables Vjx and Vjy are x and y direction components of moving vector Vj. Variable sqrt(X) expresses the square root of X. X² is an expression for calculating the square of X.

At step S013, vector difference dVkj between moving vectors Vk and Vj is compared with a predetermined constant ε, and whether or not moving vectors Vk and Vj can be regarded as a substantially identical moving vector is determined. Specifically, if vector difference dVkj is smaller than constant ε (YES at S013), then moving vectors Vk and Vj are regarded to be substantially identical, and the process is advanced to step S014. Conversely, if it is greater (NO at S013), then they are not regarded to be substantially identical, and step S014 is skipped and the process is advanced to step S015. At step S014, similarity Pk is increased by using the following equations (11)-(13).
Pk=Pk+α (11)
α=1 (12)
α=Ck max (13)

Variable α in equation (11) is a value that increases similarity Pk. Accordingly, when variable α is set as α=1 as shown in equation (12), similarity Pk is the number of partial regions having the identical moving vector with reference moving vector Vk. When variable α is set as α=Cjmax as shown in equation (13), similarity Pk is the sum of maximum matching when performing template matching with respect to the partial regions having the identical moving vector with reference moving vector Vk. The value of α may be smaller in accordance with the magnitude of vector difference dVkj.

At step S015, whether or not index j is smaller than the number of partial regions n is determined, and if it is determined that index j is smaller than the number of partial regions n (YES at S015), then the process is advanced to step S016, and if it is determined that it is greater, then (NO at S015), then the process is advanced to step S017. Specifically, at step S016, the value of index j is incremented by 1.

By the process of steps S010-S016 described above, similarity Pk using information of partial regions determined to have the same moving vector with respect to moving vector Vk of the reference is calculated. Then, at step S017, similarity Pk obtained using moving vector Vk as the reference is compared with variable P (A′, B). If similarity Pk is greater than the similarity that is maximum up to the current point (value of variable P (A′, B) (YES at S017), then the process is advanced to S018, and if smaller (NO at S017), then step S018 is skipped and the process is advanced to S019.

Specifically, at step S018, as variable P (A′, B), the value of similarity Pk derived by moving vector Vk as the reference is set. At steps S017 and S018, if similarity Pk derived by using moving vector Vk as the reference is greater than the maximum value of the similarity (value of variable P (A′, B)) derived by using other moving vectors as the reference calculated up to this time point, then moving vector Vk being the reference is most appropriate as the reference among indexes k up to the current time point.

Next, at step S019, the value of index k of moving vector Vk of the reference and the number of partial regions n (value of variable n) are compared. If index k is smaller than the number of partial regions n (YES at S019), then the process is advanced to step S020. At step S020, index k is incremented by 1.

By repeating the process of steps S008-S020 until index k reaches the number of partial regions n (NO at S019), the similarity between images A′and B is calculated as the value of variable P (A′, B). Similarity calculating part 106 stores the value of variable P (A′, B) calculated as above at a predetermined address in memory 102, and sends out a similarity calculation end signal to control unit 108, and the process is completed.

Here, the aforementioned determination at step T4 is specifically described in the following. At step T4, specifically, the similarity represented by the value of variable P (A′, B) stored in memory 102 and a predetermined collation threshold value T are compared (FIG. 5D). As a result of the comparison, if variable P (A′, B)≧T, then it is determined that images A′ and B are taken from an identical fingerprint, and as the collation result, a value indicative of “matching”, for example ‘1’, is written at a predetermined address in memory 102. Otherwise, it is determined that they are taken from different fingerprints, and as the collation result, a value indicative of “mismatching”, for example ‘0’, is written at a predetermined address in memory 102.

As described above, in image collating apparatus 1 according to the present embodiment, similarity between a set of snapshot images and another image different from the set of snapshot images is calculated by using information on a partial region corresponding to positional relationship data included in a predetermined range out of positional relationship data representing positional relationship derived by searching for positions at which a plurality of partial regions in the set of snapshot images attain maximum matching in an image different from the set of snapshot images. Accordingly, a complicated preprocess for extracting image features necessary for collation is not required, whereby the configuration of the image collating apparatus can be simplified. Further, as image collating apparatus 1 do not utilize the image features for such processing, image collation of high precision, that is less susceptible to existence, the number, sharpness or the like of image features, environmental change when inputting an image, noises and the like can be achieved.

Still further, according to image collating apparatus 1 of the present embodiment, the number of partial regions in which direction and distance of the corresponding searched maximum matching position from the reference position are within a predetermined range is calculated out of a plurality of partial regions to be output as image similarity. Thus, the image similarity can easily be obtained, by setting positional relationship as direction and distance of maximum matching position from the reference position, and setting the total number of partial regions in which these direction and distance are within a predetermined range as the similarity. Additionally, by using the sum of maximum matching of partial regions in which direction and distance of the corresponding searched maximum matching position from the reference position are within a predetermined range as the image similarity, more precise image similarity can be obtained than by simply using the sum of maximum matching of partial regions at the matched positions.

In other words, as the direction and distance of the maximum matching position from the reference position, the sum of matching of partial regions in which data of the moving vector is determined to be within a predetermined range can be used. Accordingly, for example, such a case can be avoided that a set of snapshot images and an image different from the set of snapshot images are erroneously determined to be taken from an identical finger, while they are actually the fingerprint images taken from different fingers. Further, even when the number of partial regions having the same moving vector is small due to positional displacement or the like while the images are taken from an identical finger, generally correlation between partial regions of an identical finger is higher than correlation between different fingers. Accordingly, erroneous determination can be reduced.

According to image collating apparatus 1 of the present embodiment, a plurality of partial regions that are the target of search are stored in the storing part. Accordingly, the preprocess of obtaining images of partial regions for searching for the position at which matching is maximum, which would be required when storing the input images as they are, can be eliminated. Further, the data amount to be stored can be reduced.

Second Embodiment

The processing functions of image collating apparatus 1 for image collation described in the first embodiment are realized by a program. In the present embodiment, the program is stored in a computer readable recording medium.

In the present embodiment, as the recording medium, a memory necessary for a process to be executed at the computer shown in FIG. 2, for example, memory 624 itself may be a program medium. Alternatively, it may be a recording medium removably attached to an external storage device of the computer, through which the program recorded in the medium can be read. Examples of the external storage device may include a magnetic tape device (not shown), FD driver 630, CD-ROM driver 640 and the like. Examples of the recording medium may include a magnetic tape (not shown), FD 632, CD-ROM 642 and the like. In any of the cases, the program stored in each recording medium may be configured to be accessed and executed by CPU 622. Or, in any of the cases, the program may once read from the recording medium and loaded to a predetermined program storing area in FIG. 2, for example the program storing area of memory 624 to be read and executed by CPU 624. It is noted that the program for loading is stored in the computer in advance.

Here, the recording medium is configured removably from the computer body. As such a recording medium, a recording medium that carries the program fixedly can be applied. Specifically, tape-base medium such as a magnetic tape or a cassette tape, a magnetic disc such as FD 632 or fixed disk 626, an optical disc-base medium such as CD-ROM 642/MO (Magnetic Optical Disc)/MD (Mini Disc)/DVD (Digital Versatile Disc), a card-base medium such as an IC card (including a memory card)/an optical card, a semiconductor memory such as mask ROM, EPROM (Erasable Programmable ROM), EEPROM (Electrically EPROM) (R), flash ROM can be employed.

Further, as the computer in FIG. 2 is shown employing a configuration capable of connecting to communication network 300 including the Internet for communication, the medium may be a recording medium downloading a program from communication network 300 and carrying the program in a re-writable manner. When a program is downloaded from communication network 300, a program for downloading may be stored in the computer body in advance, or it may be installed in the computer body from another recording medium in advance.

It is noted that the contents stored in the recording medium is not restricted to a program, and it may be data.

Although the present invention has been described and illustrated in detail, it is clearly understood that the same is by way of illustration and example only and is not to be taken by way of limitation, the spirit and scope of the present invention being limited only by the terms of the appended claims.

1. An image collating apparatus, comprising:
an image relative positional relationship calculating part calculating a first reference position that is relative positional relationship between two images picked up and obtained by scanning an identical target, based on matching of at least part of regions between said two images;
a first maximum matching position searching part searching for a first maximum matching position for each of said two images, said first maximum matching position being a position of an image of a partial region attaining maximum matching in another image different from said two images;
a first similarity calculating part calculating image similarity between said two images and said another image to output the calculated image similarity, by using information on said partial region corresponding to first positional relationship data included in a predetermined range out of first positional relationship data for each of said two images representing positional relationship between said first reference position calculated by said image relative positional relationship calculating part and said first maximum matching position calculated by said first maximum matching position searching part; and
a determining part determining whether or not said two images and said another image match based on said image similarity.

2. The image collating apparatus according to claim 1, wherein
said image relative positional relationship calculating part includes:
a second maximum matching position searching part searching for a second maximum matching position for each of said two images, the second maximum matching position being each of positions of images of partial regions at which a part of a plurality of images in one of said two images respectively attain maximum matching in other of said two images;
a second similarity calculating part calculating image similarity between said two images to output the calculated image similarity, by using information on said part of images corresponding to second positional relationship data included in a predetermined range out of second positional relationship data for each of said plurality of partial images of said one of two images representing positional relationship between a reference position for measuring a position of said part of images in said other image and said second maximum matching position corresponding to said part of images searched for by said second maximum matching position searching part; and
a reference position calculating part calculating said first reference position of said one of the images in said other image based on said second positional relationship data.

3. The image collating apparatus according to claim 2, wherein
said reference position calculating part calculates said first reference position based on an average value of a plurality of said second positional relationship data.

4. The image collating apparatus according to claim 2, wherein
said reference position calculating part extracts arbitrary second positional relationship data out of a plurality of said second positional relationship data, and calculate said first reference position based on the extracted second positional relationship data.

5. An image collating method, comprising the steps of:
calculating a first reference position that is relative positional relationship between two images picked up and obtained by scanning an identical target, based on matching of at least part of regions between said two images;
searching for a first maximum matching position for each of said two images, said first maximum matching position being a position of an image of a partial region attaining maximum matching in another image different from said two images;
calculating image similarity between said two images and said another image to output the calculated image similarity, by using.information on said partial region corresponding to first positional relationship data included in a predetermined range out of first positional relationship data for each of said two images representing positional relationship between said calculated first reference position and said searched first maximum matching position; and
determining whether or not said two images and said another image match based on said image similarity.

6. An image collating program product for causing a computer to execute an image collating method, said image collating program product causing the computer to execute the steps of:
calculating a first reference position that is relative positional relationship between two images picked up and obtained by scanning an identical target, based on matching of at least part of regions between said two images;
searching for a first maximum matching position for each of said two images, said first maximum matching position being a position of an image of a partial region attaining maximum matching in another image different from said two images;
calculating image similarity between said two images and said another image to output the calculated image similarity, by using information on said partial region corresponding to first positional relationship data included in a predetermined range out of first positional relationship data for each of said two images representing positional relationship between said calculated first reference position and said searched first maximum matching position; and
determining whether or not said two images and said another image match based on said image similarity.

7. A computer readable recording medium recording the image collating program product according to claim 6.
